(19) United States
(12) Patent Application Publication
(10) Pub. No.: US 2020/0410408 A1
(43) Pub. Date: Dec. 31, 2020

(54) WHEELCHAIR BOARDING INFORMATION TRANSMISSION SYSTEM AND WHEELCHAIR BOARDING INFORMATION DISPLAY SYSTEM

(71) Applicant: Toyota Jidosha Kabushiki Kaisha, Toyota-shi Aichi-ken (JP)

(72) Inventors: Masaki Shitara, Nagakute-shi (JP); Yuchi Yamanouchi, Toyota-shi (JP); Ryo Hattori, Kariya-shi (JP)

(21) Appl. No.: 16/911,612

(22) Filed: Jun. 25, 2020

(30) Foreign Application Priority Data
Jun. 28, 2019 (JP) 2019-121601

(51) Int. Cl. G06Q 10/02; G08G 1/123; G08G 1/00; H04W 4/029; H04W 4/42; G06Q 50/30

(52) U.S. Cl. CPC G06Q 10/02; G08G 1/123; G06Q 50/30; H04W 4/029; H04W 4/42; G08G 1/20

(57) ABSTRACT

An autonomous driving vehicle is a bus provided with wheelchair passenger spaces therein. The autonomous driving vehicle detects whether or not a wheelchair is on board in the wheelchair passenger spaces, and transmits the obtained wheelchair boarding information to a control center. The control center transmits the received wheelchair boarding information to a bus stop sign and causes the bus stop sign to display the information on a display of the bus stop sign. The wheelchair boarding information can also be displayed on a touch panel display of a smartphone.

### CROSS REFERENCE TO RELATED APPLICATION

This application claims priority to Japanese Patent Application No. 2019-121601 filed on Jun. 28, 2019, which is incorporated herein by reference in its entirety including the specification, claims, drawings, and abstract.

### TECHNICAL FIELD

The present disclosure relates to a wheelchair boarding information transmission system and a wheelchair boarding information display system for a vehicle provided with wheelchair passenger spaces.

### BACKGROUND

Autonomous driving vehicles capable of self-driving have been known. Self-driving means that at least part of drive control including, for example, vehicle speed control and steering control is performed by a computer. Generally, an autonomous driving vehicle has a plurality of driving modes including an autonomous driving mode in which self-driving is performed and a manual driving mode in which drive control is performed by an operator on board the autonomous driving vehicle. Development and practical application of autonomous driving vehicles is directed at various types of vehicles including, for example, general cars and buses.

Some vehicles have wheelchair passenger spaces so that wheelchair users can be on board while sitting in their wheelchairs. JP 2001-47969 A discloses a seatbelt installed in a wheelchair passenger space in a vehicle which carries a number of people, such as a bus or a van.

### SUMMARY

Whether or not a wheelchair user can board a vehicle having wheelchair passenger spaces depends on the availability of the wheelchair passenger spaces. However, generally, in a vehicle where a number of unspecified users are on board, such as a bus, it is difficult to check the availability of wheelchair passenger spaces. In, for example, in an autonomous driving vehicle running in the autonomous driving mode where no operator is on board, it is more difficult to check the availability of wheelchair passenger spaces.

For example, if the availability of wheelchair passenger spaces in a bus is unknown, and the bus has arrived at a bus stop, a wheelchair user who has been waiting for arrival of the bus at the bus stop may try to board the bus and see the wheelchair passenger spaces in the bus, only to realize that they are fully occupied. The wheelchair user may thus have to give up boarding the bus. This situation can be a burden to the wheelchair user, and may also cause extension of boarding and alighting time at the bus stop.

An object of the present disclosure is to convey the availability of wheelchair passenger spaces in a vehicle having the wheelchair passenger spaces to a potential user of the vehicle (hereinafter called simply “user”) before the user boards the vehicle.

A wheelchair boarding information transmission system according to the present disclosure has a detection device that detects whether or not, in a vehicle provided with a wheelchair passenger space, a wheelchair is on board in the wheelchair passenger space, and a transmitting device that transmits information about whether or not the wheelchair is on board to the outside of the vehicle based on the detection result of the detection device.

A wheelchair boarding information display system according to the present disclosure has a receiving device that receives information about whether or not a wheelchair is on board, the information being transmitted from a vehicle provided with a wheelchair passenger space, and a display device that displays, based on the received information, whether or not another wheelchair is able to board the vehicle. In an aspect of the wheelchair boarding information transmission system according to the present disclosure, the system has an input and correction device with which an operator who is on board the vehicle inputs the information about whether not the wheelchair is on board or corrects the information.

With the wheelchair boarding information transmission system according to the present disclosure, it is possible for a vehicle provided with wheelchair passenger spaces to convey to the outside of the vehicle information about whether or not there is a vacancy in the wheelchair passenger spaces.

With the wheelchair boarding information display system according to the present disclosure, it is possible for a user to know, before boarding a vehicle provided with wheelchair passenger spaces, information about whether or not there is a vacancy in the wheelchair passenger spaces.

### BRIEF DESCRIPTION OF DRAWINGS

An embodiment of the present disclosure will be described based on the following figures, wherein:

FIG. 1 is a view showing a system configuration according to an embodiment;

FIG. 2 is a view showing the interior space of an autonomous driving vehicle;

FIG. 3 is a flowchart showing a process of obtaining and transmitting wheelchair boarding information;

FIG. 4 is a flowchart showing a process of detecting a wheelchair;

FIG. 5 is a flowchart showing a process of receiving and displaying the wheelchair boarding information; and

FIG. 6 is a view showing a display example of the wheelchair boarding information.

### DESCRIPTION OF EMBODIMENTS

Hereinafter, an embodiment will be described with reference to the drawings.

Although, in the description, specific aspects will be described for easy understanding, these aspects exemplify the embodiment, and a variety of other embodiments are possible.

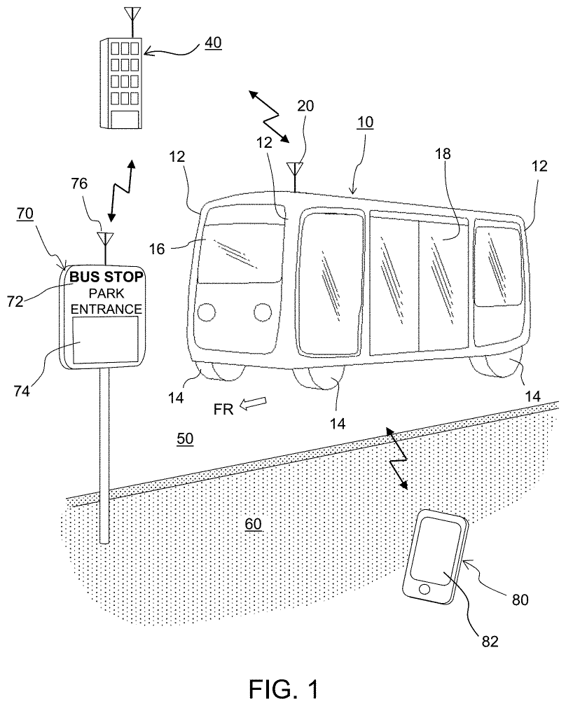

FIG. 1 is a view showing an overview of a system configuration according to the present embodiment. In this figure, an autonomous driving vehicle 10 is a bus-type vehicle which carries a number of unspecified passengers. In the present embodiment, the autonomous driving vehicle 10 is used as a bus that transports the passengers while running along a predefined route of a roadway 50 within a particular site. This figure also illustrates a control center 40, a sidewalk 60, a bus stop sign 70 installed on the sidewalk 60, and a smartphone 80 of a user waiting for the autonomous driving vehicle 10.

The autonomous driving vehicle 10 runs on the roadway 50, assuming that the direction of an arrow indicated by reference sign FR is the forward direction. The autonomous driving vehicle 10 is generally rectangular parallelopiped and symmetric along the front-and-rear direction. The design of its external appearance is also symmetric along the front-and-rear direction. On the four corners of the autonomous driving vehicle 10 in a plane view, there are pillars 12 extending in the up-and-down direction, and a wheel 14 is provided under each pillar 12. A large part of each of the front, rear, right, and left side surface walls of the autonomous driving vehicle 10 is composed of a translucent panel 16. The panel 16 may be a display panel which can display, for example, wheelchair boarding information described below.

Some panels on the left side surface facing the sidewalk constitute a slidable door 18, and passengers can board and alight from the bus when the door 18 slides and opens. In addition, a retractable ramp (not shown in FIG. 1) is stored under the door 18. The ramp is used when a wheelchair user boards and alights from the vehicle.

The autonomous driving vehicle 10 has an antenna 20 installed thereon. The antenna 20 is provided for wireless connection to the network. The autonomous driving vehicle 10 can wirelessly communicate, through the antenna 20, with the control center 40, which controls running of the autonomous driving vehicle 10. The autonomous driving vehicle 10 can also be connected, through the antenna 20, to a variety of communication devices connected to the network.

The autonomous driving vehicle 10 is a vehicle that is capable of self-driving. Specifically, the autonomous driving vehicle 10 can be driven in a plurality of driving modes including an autonomous driving mode and a manual driving mode. In the present embodiment, a control mode by the control center and a control mode by the autonomous driving vehicle 10 are provided as the autonomous driving modes.

The autonomous driving mode is a mode in which a computer mainly performs drive control. In the specification, the concept of drive control encompasses gear shift control, vehicle speed control, and steering control. In addition, vehicle speed control is a concept that encompasses start control, stop control, and acceleration/deceleration control of the autonomous driving vehicle 10.

Of the autonomous driving modes, the control mode by the control center is a mode in which a computer mounted on the autonomous driving vehicle 10 performs drive control according to drive instructions from the control center. The control center is provided in order to manage and control a plurality of autonomous driving vehicles 10 and is configured to be communicable with each of the autonomous driving vehicles 10. In the control mode by the control center, the travel route of the autonomous driving vehicle 10 is determined according to instructions from the control center. In addition, drive control by the computer mounted on the autonomous driving vehicle 10 is also mostly performed according to instructions from the control center. However, in the present embodiment, start control to start from a stop state is performed upon receipt of instructions input through operation by an operator who is on board the autonomous driving vehicle 10.

Of the autonomous driving modes, the control mode by the autonomous driving vehicle 10 is a driving mode in which, basically, instructions from the outside are not received, and drive control of the autonomous driving vehicle 10 is mostly performed based only on determination by the computer mounted on the autonomous driving vehicle 10. In the control mode by the autonomous driving vehicle 10 in the present embodiment, the computer on the autonomous driving vehicle 10 performs drive control based on the detection results from a variety of types of sensors provided on the autonomous driving vehicle 10 (for example, a camera or a lidar) such that the autonomous driving vehicle 10 runs along the predefined route, without receiving instructions from the control center. However, start control to start from a stop state is performed upon receipt of instructions through operation by the operator who is on board the autonomous driving vehicle 10.

The manual driving mode is a mode in which the autonomous driving vehicle 10 does not perform autonomous driving, and the operator who is on board the autonomous driving vehicle 10 performs drive control of the autonomous driving vehicle 10.

The operator is a person who is on board the autonomous driving vehicle 10 and participates in control of the autonomous driving vehicle 10. Although, in the autonomous driving mode, the control center or the autonomous driving vehicle 10 itself mainly performs drive control, and therefore, there are a few opportunities for the operator to perform drive control, the operator participates in start control to start from a stop state and also has the authority to perform deceleration control and the like as described below. It can therefore be said that the operator participates in control of the autonomous driving vehicle 10. In the manual driving mode, the operator serves as a driver who directly performs drive operation of the autonomous driving vehicle 10. It can thus be said that the operator participates in control of the autonomous driving vehicle 10.

The autonomous driving vehicle 10 is used as a bus and repeats start and stop relatively frequently. The autonomous driving vehicle 10 is assumed to run at a relatively low speed (for example, 30 km/h or lower).

However, the form of use of the autonomous driving vehicle 10 disclosed in the present specification may be changed appropriately. For example, the autonomous driving vehicle 10 may be used as a movable business space, such as, for example, a retail store where various types of products are displayed and sold, or a store where foods and drinks are prepared and served, such as a restaurant. In another form of use, the autonomous driving vehicle 10 may be used as an office for office work or for a meeting with a client, for example. Further, the use of the autonomous driving vehicle 10 is not limited to business purposes, and it may be used as a personal transportation, for example. A running pattern and the vehicle speed of the autonomous driving vehicle 10 may also be changed appropriately.

The autonomous driving vehicle 10 is an electric car having, as a motor, a drive motor which is powered from a battery. This battery is a rechargeable secondary battery and is periodically charged with external power. In addition, the autonomous driving vehicle 10 is not limited to an electric car and may be other types of cars. For example, the autonomous driving vehicle 10 may be an engine car in which an engine is mounted as a motor, or may be a hybrid car in which an engine and a drive motor are mounted as motors. Further, the autonomous driving vehicle 10 may be a hydrogen car in which a drive motor is driven by power generated by a fuel cell.

The control center 40 is provided at a remote location and controls operation of the plurality of autonomous driving vehicles 10 through communication. The control center 40 also obtains wheelchair boarding information from the autonomous driving vehicles 10, performs appropriate processing of the information, and then transmits the resulting information to the bus stop sign 70, the smartphone 80 of the user, and elsewhere.

The bus stop sign 70 is provided to define a location of a bus stop and is installed on the sideway 60. The bus stop sign 70 is provided with an information board 72 on which are displayed, for example, indications that it is a “bus stop” and that the name of the bus stop is “Park Entrance.” The information board 72 has a display 74 embedded on its lower side. The display 74 displays, based on information transmitted from the control center 40, guide information for the user waiting for the autonomous driving vehicle 10, and commercial advertisements. The display 74 can display not only a timetable and the operation status of the bus but also wheelchair boarding information as described below. The display 74 may be in the form of a touch panel which receives operations by the user. In this case, the user can operate the display 74 to instruct the display 74 to display the wheelchair boarding information.

The bus stop sign 70 is provided with an antenna 76. The antenna 76 is provided for wireless connection to the network. The sign 70 receives information to be displayed on the display 74 from the control center 40 or elsewhere through the antenna 76. The sign 70 has therein computer hardware having a communication circuit, an arithmetic circuit, and a storage circuit, and software to control the computer hardware. The hardware and software process the received data according to a program and cause the display 74 to display the result. The sign 70 may be installed with, for example, a dedicated application program to cause the display 74 to display contents specialized for bus stops. Alternatively, the control center 40 may perform main arithmetic processing, and the sign 70 may perform only processing of displaying the received data on the display 74.

The smartphone 80 is a portable terminal device held by the user waiting for the autonomous driving vehicle 10. The smartphone 80 is provided with a touch panel display 82. The smartphone 80 also has therein an antenna for wireless communication as well as computer hardware, such as a communication circuit, an arithmetic circuit, and a storage circuit, and software to control the computer hardware. The smartphone 80 may be installed with, for example, an application program developed for users of the autonomous driving vehicle 10. When this application program is activated on the smartphone 80, the user can operate the touch panel display 82 to cause the display 82 to display, for example, the timetable, the operation status, and the wheelchair boarding information of the autonomous driving vehicle 10 provided from the control center 40.

The user also can use the application to make a reservation for a wheelchair space in the autonomous driving vehicle 10 the user wants to board. For example, the user makes a user registration in advance through the application. The user then can input, through the application, information about the vehicle the user wants to board, a section of the road over which the user wants to travel on the vehicle, a wheelchair passenger space number, and the like, to thereby make a reservation for wheelchair boarding.

If, for the autonomous driving vehicle 10, wheelchair boarding is implemented by reservation-only, whether or not a reservation for wheelchair boarding is possible is known by processing only reservation information obtained from users. However, if the autonomous driving vehicle 10 accepts wheelchair boarding without a reservation, a determination as to whether a reservation for wheelchair boarding is possible is made by integrating processing of the reservation information with processing of detecting a wheelchair on board described below. That is, the autonomous driving vehicle 10 always detects whether a wheelchair is on board in the wheelchair passenger spaces. The detection results and the reservation information for wheelchair boarding obtained at that point of time are combined to enable a determination as to whether a new reservation for wheelchair boarding is possible. To know the status of wheelchair boarding accurately, it is necessary to check whether a passenger who is on board in a wheelchair passenger space is a passenger who actually made a reservation for that wheelchair passenger space, or another passenger. To this end, through the application, it is possible to cause a passenger who boards the vehicle by a reservation to input, for example, information indicating that the passenger has boarded and alighted from the vehicle. Also, information about boarding and alighting of a passenger who has been registered as a user may be automatically obtained through a near field wireless communication system provided in the autonomous driving vehicle 10. Such a near field wireless communication system may include those used at a security gate and a tollgate, for example.

The information about the status of wheelchair boarding and the possibility of a reservation is provided in a manner that can be seen by all users, for example, through the application. The information is also provided on the bus stop sign 70 so that anyone can check it. Thus, it becomes easier for the user to board the autonomous driving vehicle 10 in a wheelchair at a time when the user wants to move. In addition, even if there is no vacancy in the wheelchair passenger spaces in the autonomous driving vehicle 10 which the user attempts to board, with information about the possibility of a reservation, it is possible for the user to know, for example, information that, at the bus stop where the user is now, a person who is on board in a wheelchair will alight, and hence there will be a vacancy in the wheelchair passenger spaces. Thus, for example, it becomes possible to make a plan for wheelchair boarding in advance, thereby enhancing the convenience for wheelchair users.

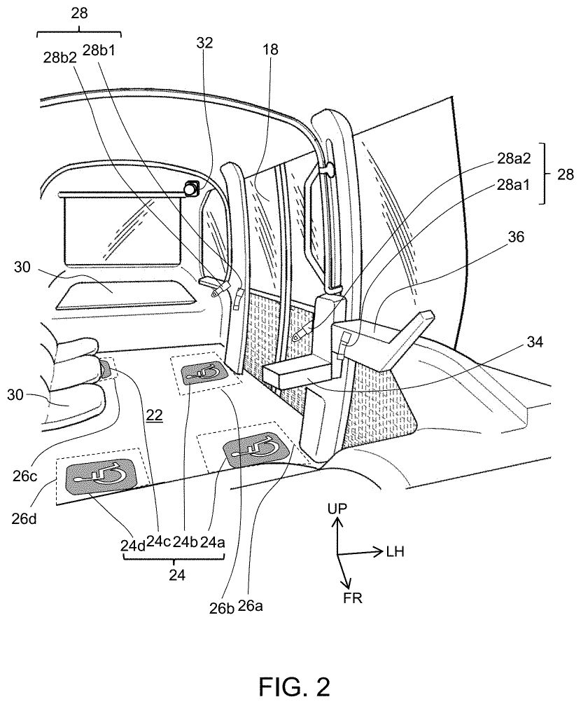

Next, the interior of a vehicle chamber of the autonomous driving vehicle 10 will be described with reference to FIG. 2. FIG. 2 is a perspective view illustrating the interior of the vehicle chamber of the autonomous driving vehicle 10. In the coordinate system in this figure, FR indicates the vehicle forward direction. LH indicates the left direction when facing the front of the vehicle. UP indicates the vertically upward direction.

The autonomous driving vehicle 10 is used as a bus as described above, and therefore, the center portion in the vehicle chamber is a flat floor 22. The floor 22 provides a space for standing passengers, and wheelchair users sitting in their wheelchairs. The autonomous driving vehicle 10 has, on the floor 22, four wheelchair passenger spaces 24a, 24b, 24c, and 24d (these will be sometimes referred to as wheelchair passenger spaces 24) for placing wheelchairs. The wheelchair passenger spaces 24a and 24b are provided on the respective sides of the door 18, and the wheelchair spaces 24c and 25d are provided near the side wall opposite to the door 18. Portions of the floor 22 that are close to the wheelchair passenger spaces 24a, 24b, 24c, and 24d respectively have load sensors 26a, 26b, 26c, and 26d embedded therein, for detecting the presence or absence of wheelchairs (these will be sometimes referred to as load sensors 26). The detection results from the load sensors 26a, 26b, 26c, and 26d are used to detect the presence or absence of wheelchairs in the wheelchair passenger spaces 24a, 24b, 24c, and 24d, respectively. In addition, the side walls near the wheelchair passenger spaces 24 are provided with seatbelts 28 for protecting passengers sitting in their wheelchairs and stabilizing the wheelchairs. FIG. 2 illustrates a pair of seatbelts 28a1 and 28a2 for the wheelchair passenger space 24a, and a pair of seatbelts 28b1 and 28b2 for the wheelchair passenger space 24b (these pair of seatbelts 28a1 and 28a2 and pair of seatbelts 28b1 and 28b2 will be sometimes referred to as seatbelts 28). A buckle of the seatbelts 28 has a sensor mounted thereon, for electrically detecting wearing of the seatbelts 28. The detection results from the sensors are used to detect the presence or absence of wheelchairs in the wheelchair passenger spaces 24a, 24b, 24c, and 24d.

Seats 30 for passengers who do not use wheelchairs are provided around the floor 22 along the side walls in the vehicle chamber. A camera 32 for capturing an image of the interior of the vehicle chamber is also provided near the ceiling in the vehicle chamber. The image captured by the camera 32 is used to detect the presence or absence of a wheelchair in the wheelchair passenger spaces 24.

The autonomous driving vehicle 10 is provided with an operator seat 34 for an operator who performs drive control of the autonomous driving vehicle 10 and operates devices provided in the autonomous driving vehicle 10 (an air conditioner, a windshield wiper, and the like). The operator is a driver in the manual driving mode, while, in the autonomous driving mode, the operator basically does not perform drive operation. Although, in FIG. 2, a seat portion of the operator seat 34 is lowered and set to be used so that an operator can sit thereon, the seat portion can be flipped up. The operator seat 34 is located at a position that overlaps with the wheelchair passenger space 24a. Thus, if the seat portion of the operator seat 34 is set to be used, the wheelchair passenger space 24a is not used.

On the front side of the operator seat 34, there is provided an arm rest 36 extending in the front-and-rear direction, for resting the arm of the operator sitting on the operator seat 34. The arm rest 36 has a touch panel installed thereon for use by the operator in the autonomous driving mode, and stores a mechanical operation unit used by the operator in the manual driving mode. The arm rest 36 also has, on its upper surface, a mechanical emergency stop button for manually inputting emergency stop instructions to the autonomous driving vehicle 10. All of the touch panel, the mechanical operation unit, and the emergency stop switch are made to be manually operated by the operator. The autonomous driving vehicle 10 has no foot pedals operated by foot for inputting vehicle speed control instructions, such as an accelerator pedal or a brake pedal provided in a conventional vehicle.

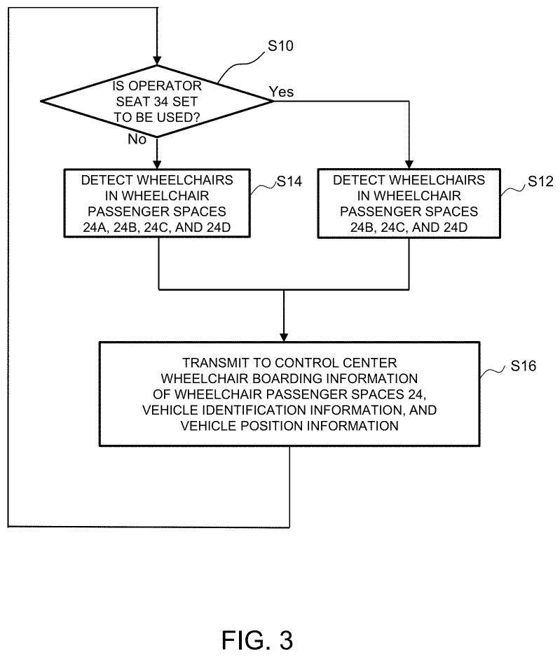

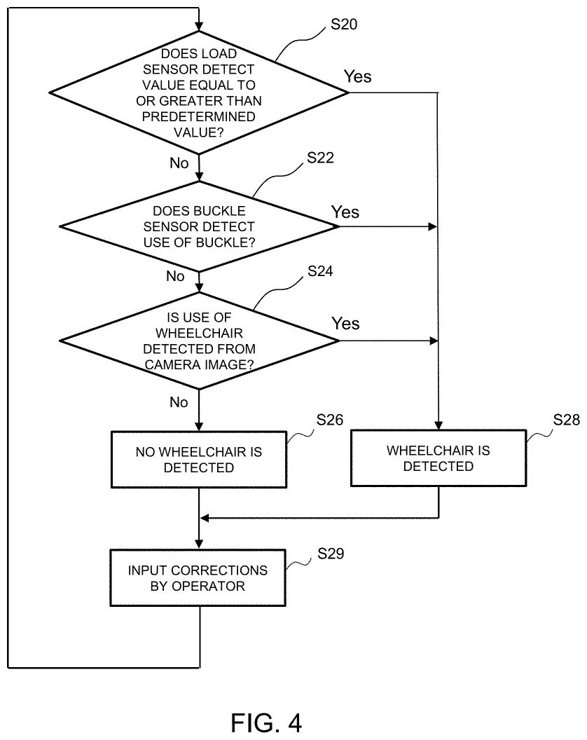

Next, obtaining of wheelchair boarding information in the autonomous driving vehicle 10 will be described with reference to FIGS. 3 and 4. Here, the wheelchair boarding information is information about whether or not a wheelchair is on board in the wheelchair boarding spaces 24 in the autonomous driving vehicle 10. The wheelchair boarding information includes, for example, information about whether there is a vacancy in the wheelchair boarding spaces 24, whether the wheelchair boarding spaces 24 are used, and whether a wheelchair can board the autonomous driving vehicle 10.

FIGS. 3 and 4 are flowcharts indicating flows of processing of detecting the wheelchair passenger spaces 24 that is periodically performed in the autonomous driving vehicle 10. As shown in FIG. 3, the autonomous driving vehicle 10 first detects whether or not the operator seat 34 is set to be used (S10). Whether or not the operator seat 34 is set to be used can be detected by a sensor provided in the operator seat 34. When the operator seat is set to be used, the wheelchair passenger space 24a cannot be used, and therefore, detection of a wheelchair in the remaining three wheelchair passenger spaces 24b, 24c, and 24d is performed (S12). On the other hand, when the operator seat is not set to be used, the wheelchair passenger space 24a can be used, and therefore, detection of a wheelchair in the four wheelchair passenger spaces 24a, 24b, 24c, and 24d is performed (S14). After the end of detection, the obtained wheelchair boarding information, identification information of the autonomous driving vehicle 10, position information of the autonomous driving vehicle 10, and the like are transmitted to the control center 40 (S16).

FIG. 4 indicates the processing of detecting the presence of a wheelchair in the wheelchair passenger spaces 24 in steps S12 and S14. In the autonomous driving vehicle 10, the presence or absence of a wheelchair is determined periodically based on outputs from the load sensors 26 embedded under the wheelchair passenger spaces 24 (S20). Although specific determination processing depends on properties of the load sensors 26, it is possible to make a determination that a wheelchair is placed (S28), for example, by using a sensor with high spatial resolution and detecting (S20) application of a load having a value greater than a predetermined value to a pattern of two wheels that are arranged generally in parallel to each other with an appropriate interval therebetween.

If the load sensors 26 detect no wheelchair, then the buckle sensors on the seatbelts 28 perform detection (S22). The buckle sensor can detect fastening of a pair of buckles when the seatbelts 28 for a wheelchair user is used. Therefore, if the buckle sensor detects fastening of the buckle, it means that the presence of a wheelchair is detected (S28).

If the buckle sensor detects no wheelchair on board, then, for example, processing of extracting a wheelchair pattern is performed on an image captured near each of the wheelchair passenger spaces 24 by the camera 32 (S24). If a pattern of a wheelchair is extracted, it means that the presence of a wheelchair is detected (S28). On the other hand, when no pattern of a wheelchair is detected, a determination is made that no wheelchair is on board (S26). If an operator is on board, the operator may input wheelchair boarding information or correct the information (S29). The operator may operate the touch panel of the arm rest 36 and input or correct wheelchair boarding information at any time, based on the results from visual observation. Input and correction by the operator may be performed in addition to detection by the sensors. In doing so, it becomes possible to improve the accuracy in detecting a wheelchair on board. Input and correction by the operator may also be performed when detection by the sensors is not performed. This enables detection of a wheelchair even in the autonomous driving vehicle 10 where no sensors are introduced.

The wheelchair detecting processing shown in FIG. 4 is an example, and detection may be performed based on other methods. For example, a determination that a wheelchair is on board may be made only when detection by the load sensor (S20), detection by the buckle sensor (S22), and detection by a camera image (S24) all indicate that a wheelchair is on board. It is also possible to determine that a wheelchair is on board when both detection by the load sensor (S20) and detection by the buckle sensor (S22), both detection by the buckle sensor (S22) and detection by a camera image (S24), or both detection by the load sensor (S20) and detection by a camera image (S24) indicate that a wheelchair is on board. As a matter of course, other sensors (such as, for example, an infrared sensor and a temperature sensor) may be used to detect the presence or absence of a wheelchair or a wheelchair user.

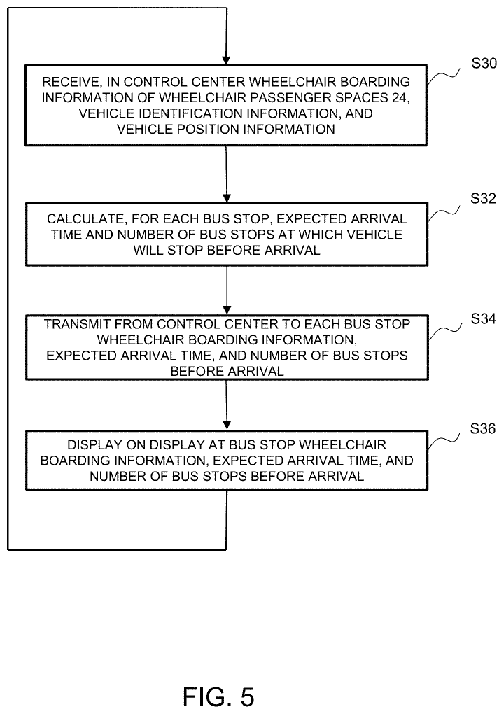

FIG. 5 is a flowchart indicating processing of conveying wheelchair boarding information to the user waiting for the autonomous driving vehicle 10. The control center 40 periodically receives, from the autonomous driving vehicle 10, wheelchair boarding information, identification information for identifying the relevant autonomous driving vehicle 10, and position information of the autonomous driving vehicle 10 (S30). In the case where the control center 40 accepts a reservation for wheelchair boarding, it also receives information about a reservation status, in addition to the wheelchair boarding information. The control center 40 calculates, for each bus stop, the expected arrival time of the autonomous driving vehicle 10 and the number of bus stops at which the autonomous driving vehicle 10 will stop before arriving at the relevant bus stop (S32). The control center 40 then transmits to each bus stop correspondingly the wheelchair boarding information, the calculated expected arrival time, the number of bus stops at which the vehicle 10 will stop before arriving at the relevant bus stop, and the like (S34). Each bus stop displays the received wheelchair boarding information, expected arrival time, number of bus stops at which the vehicle 10 will stop before arriving at the relevant bus stop, and the like on the display 74 of the bus stop sign 70 (S36).

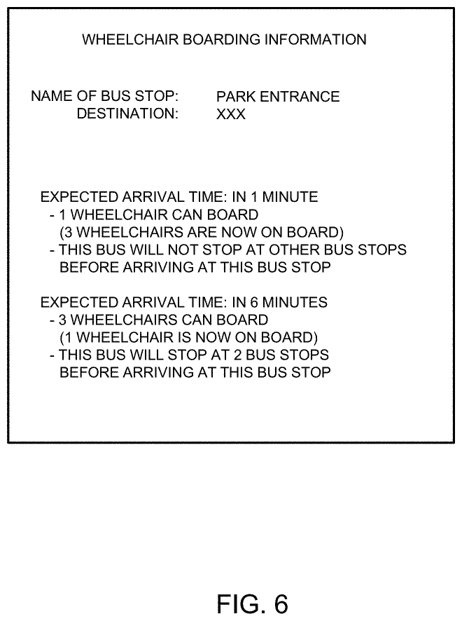

FIG. 6 shows an example of wheelchair boarding information displayed on the display 74 of the bus stop sign 70. In FIG. 6, the display indicates that the information is “wheelchair boarding information”, the “name of the bus stop” is “Park Entrance”, and that the destination is “XXX”. Below these indications, the display also indicates, for the autonomous driving vehicle 10 whose “expected arrival time” is “in one minute”, wheelchair boarding information that “one wheelchair can board (three wheelchairs are now on board)”, and information that the vehicle 10 “will not stop at other bus stops before arriving at this bus stop”.

The display further indicates, for the next arriving autonomous driving vehicle 10, information that the “expected arrival time” is “in six minutes”, “three wheelchairs can board (one wheelchair is now on board)”, and that the vehicle 10 “will stop at two other bus stops before arriving at this bus stop”.

Therefore, the wheelchair user waiting for the autonomous driving vehicle 10 recognizes that the bus which will be arriving in one minute will not stop at other bus stops on the way, and therefore, one wheelchair will certainly be able to board the bus. The wheelchair user waiting for this autonomous driving vehicle 10 also recognizes that if no wheelchair user alights from the autonomous driving vehicle 10 when it has arrived, and if another wheelchair boards the vehicle, the wheelchair user should give up boarding the vehicle and wait for the next autonomous driving vehicle 10. It is then possible for the wheelchair user to have a consideration that, although the next autonomous driving vehicle 10 will be arriving at two other bus stops on the way, and it is thus unclear whether the wheelchair user certainly can board this autonomous driving vehicle 10, at the moment, there is still a possibility that the wheelchair user can board the vehicle, and it will be worth waiting six minutes.

In the example in FIG. 6, the information such as the expected arrival time and the number of bus stops at which the vehicle 10 will stop before arriving at the relevant bus stop is additional information that is displayed in addition to the wheelchair boarding information. Although the additional information is convenient if it is displayed, it does not have to be displayed, in order to avoid excessive display information.

In addition, the example in FIG. 6 does not include information which is displayed when a reservation for wheelchair boarding has been made. If a reservation for wheelchair boarding has been made, indications on the display may be provided in consideration of information about at which bus stop a passenger who is now actually on board the autonomous driving vehicle 10 by reservation will alight and information about from which bus stop to which bus stop a user who has already made a reservation and will board the vehicle from now will travel. For example, FIG. 6 may include an indication such as, for example, “two wheelchairs can board (one wheelchair is now on board, one wheelchair space is reserved)” as an information item for the autonomous driving vehicle 10 arriving in six minutes.

The wheelchair boarding information can be displayed on the touch panel display 82 of the smartphone 80. By activating the application program and selecting the bus stop and the destination on the smartphone 80, the user can cause the touch panel display 82 to display the same information as in FIG. 6.

The wheelchair boarding information may further be displayed on a display mounted on the panel 16 of the autonomous driving vehicle 10. The wheelchair user who has been waiting for the autonomous driving vehicle 10 at the bus stop can check the wheelchair boarding information on the display of the autonomous driving vehicle 10 actually arrived in front of the wheelchair user, to thereby certainly know whether wheelchair boarding is possible.

In the above description, the wheelchair boarding information is transmitted from the autonomous driving vehicle 10 to the control center 40 and then transmitted from the control center 40 to the bus stop sign 70 or the smartphone 80. However, it is also possible to adopt other communication paths, such as, for example, direct transmission from the autonomous driving vehicle 10 to the bus stop sign 70 or the smartphone 80.

In addition, the form of display of the wheelchair boarding information shown in FIG. 6 is a mere example, and wheelchair boarding information may be displayed in various other forms. For example, in place of the display by language, it is also possible to display the status of use or the availability of the wheelchair passenger spaces by illustration, for example, by displaying the number of vacant wheelchair spaces using a corresponding number of wheelchair symbols. If illustration is used, wheelchair boarding information can be conveyed to the user without depending on a language that the user can read.

In the above, the description has been made for the embodiment directed at the autonomous driving vehicle 10 having the autonomous driving mode. However, the present embodiment is similarly applicable to a manual driving vehicle.

1. A wheelchair boarding information transmission system comprising:
a detection device that detects whether or not, in a vehicle provided with a wheelchair passenger space, a wheelchair is on board in the wheelchair passenger space; and
a transmitting device that transmits information about whether or not the wheelchair is on board to the outside of the vehicle based on the detection result of the detection device.

2. A wheelchair boarding information display system comprising:
a receiving device that receives information about whether or not a wheelchair is on board, the information being transmitted from a vehicle provided with a wheelchair passenger space; and
a display device that displays, based on the received information, whether or not a new wheelchair is able to board the vehicle.

3. The wheelchair boarding information transmission system according to claim 1, further comprising an input and correction device with which an operator who is on board the vehicle inputs the information about whether not the wheelchair is on board or corrects the information.
